(19) United States
(12) Patent Application Publication
(10) Pub. No.: US 2024/0109109 A1
(43) Pub. Date: Apr. 4, 2024

(54) Dust removal system for laser cleaning machine

(71) Applicant: Luoyang Xincheng Precision Machinery Co., Ltd., Luoyang (CN)

(72) Inventors: Shaobo ZHANG, Luoyang (CN); Xiangyang DING, Luoyang (CN); Shaohui CAO, Luoyang (CN); Xiangqian LIU, Luoyang (CN)

(21) Appl. No.: 17/955,180

(22) Filed: Sep. 28, 2022

(51) Int. Cl. B08B 15/04; B08B 7/00; B23K 26/14; B23K 26/142; B23K 26/16

(52) U.S. Cl. CPC B08B 15/04; B08B 7/0042; B23K 26/142; B23K 26/1464; B23K 26/16

(57) ABSTRACT

A dust removal system for a laser cleaning machine, including: a filter, a gas pump, a gas pipe and a dustproof nozzle. The dustproof nozzle is fixed on a laser cleaning head provided with a laser cleaning head gas inlet and a laser cleaning head gas outlet; one end of the gas pump is connected to the filter, and the other end thereof is connected to the laser cleaning head gas inlet through the gas pipe; a dustproof nozzle gas inlet is provided on both sides of the dustproof nozzle, a dustproof nozzle gas outlet is provided on the front end of the dustproof nozzle; and the laser cleaning head gas outlet is connected to the dustproof nozzle gas inlet through a pipeline assembly. The present disclosure has the advantages of keeping a lens clean, prolonging service life of the lens, reducing time for replacing the lens, and reducing costs.

### TECHNICAL FIELD

The present disclosure relates to the field of laser cleaning machines, and in particular, to a dust removal system for a laser cleaning machine.

### BACKGROUND

A laser cleaning machine uses high-frequency laser pulses to generate shock waves, and the shock waves cause the attachments on the surface of the cleaned object into dust, gasification and stripping, thereby achieving the effect of removing attachments. The dust attachments that have been gasified and stripped are easy to fall on a lens of the laser cleaning head, causing contamination of the lens. Contamination of the lens causes the laser to be aggregated at the dust when passing through the lens, resulting in high temperature, and thereby causing the lens to burn out. It is a common problem that the lens of laser cleaning machine is burned due to contamination. Replacement of lenses not only affects working efficiency, but also increases costs.

### SUMMARY

The objective of the present disclosure is to provide a dust removal system for a laser cleaning machine, so as to solve a problem that a lens of a laser cleaning head for a laser cleaning machine is burned out due to contamination.

In order to achieve the above objective, the present disclosure provides the following technical solutions:

a dust removal system for a laser cleaning machine, comprising: a filter, a gas pump, a gas pipe, and a dustproof nozzle, wherein the dustproof nozzle is fixed on a laser cleaning head, a laser cleaning head gas inlet and a laser cleaning head gas outlet are provided on the laser cleaning head; one end of the gas pump is connected to the filter, and the other end of the gas pump is connected to the laser cleaning head gas inlet by means of the gas pipe; a dustproof nozzle gas inlet is provided on both sides of the dustproof nozzle, a dustproof nozzle gas outlet is provided on the front end of the dustproof nozzle, and the laser cleaning head gas outlet is connected to the dustproof nozzle gas inlet by means of a pipeline assembly; gas passes through the filter to filter the dust in the air and enters the gas pump for pressurization, then reaches the interior of the laser cleaning head by means of the gas pipe, and is blown out of the dustproof nozzle gas outlet by blowing on both sides of the pipeline assembly to form an internal positive pressure.

Further, the pipeline assembly comprises a main gas inlet elbow, bypass three-way pipes, branch gas pipes on two sides, and branch gas inlet elbows on two sides, and the laser cleaning head gas outlet is correspondingly connected to the dustproof nozzle gas inlet by means of the main gas inlet elbow, the bypass three-way pipes, the branch gas pipe elbows on the two sides, and the branch gas inlet elbows on the two sides.

Further, one end of the dustproof nozzle is of a circular structure and in bolted connection with a laser cleaning head, and the other end of the dustproof nozzle is of a flat structure.

Further, a seal ring is provided at a connection end face of the dust-proof nozzle and the laser cleaning head.

Further, the dustproof nozzle gas inlet is in threaded connection.

The present disclosure has the following beneficial effects:

In the present disclosure, by means of a built-in gas pump, a dust-proof nozzle is mounted on a laser cleaning head to form a positive pressure, so that a lens of the laser cleaning head is isolated from dust, thereby ensuring that the dust cannot reach the lens, keeping the lens clean, prolonging the service life of the lens, reducing the time for replacing the lens, and reducing costs.

The technical solution of the present disclosure reduces the operation difficulty, greatly reduces replacement time and working intensity, and reduces costs.

### BRIEF DESCRIPTION OF THE DRAWINGS

The accompanying drawings, which form a part of the present application, are used to provide a further understanding of the present disclosure. The schematic embodiments of the present disclosure and the description thereof are used to explain the present disclosure, and do not form improper limits to the present disclosure, in which

FIG. 1 is an overall structural diagram of the present disclosure;

FIG. 2 is a partial structural schematic diagram of the laser cleaning head of the present disclosure;

FIG. 3 is a schematic diagram of a mounting structure between a dustproof nozzle and a laser cleaning head according to the present disclosure;

FIG. 4 is a three-dimensional view 1 of a dustproof nozzle according to the present disclosure;

FIG. 5 is a three-dimensional view 2 of a dustproof nozzle according to the present disclosure;

FIG. 6 is a sectional diagram of a dustproof nozzle according to the present disclosure; and

FIG. 7 is a structural schematic diagram of the laser cleaning head of the present disclosure (after the dustproof nozzle is removed);

Reference numerals: 1. filter; 2. gas pump; 3. gas pipe; 4. dustproof nozzle; 5. laser cleaning head; 6. laser cleaning head gas inlet; 7. laser cleaning head gas outlet; 8. dustproof nozzle gas inlet; 9. dustproof nozzle gas outlet; 10. seal ring; 11, gas inlet elbow; 12. bypass three-way pipe; 13. branch gas pipe; 14. branch gas inlet elbow; 15. lens.

### DETAILED DESCRIPTION OF THE EMBODIMENTS

The present disclosure will be described below with reference to the drawings and embodiments in detail. The respective examples are provided by way of explanation of the present disclosure without limiting the present disclosure. Indeed, it will be apparent to those skilled in the art that modifications and variations can be made in the present disclosure without departing from the scope or spirit of the present disclosure. For example, features illustrated or described as being part of one embodiment may be used in another embodiment to yield yet another embodiment. Therefore, it is intended that the present disclosure cover such modifications and variations falling within the scope of the appended claims and their equivalents. The description and drawings are intended to enable any person skilled in the art to make and use the present disclosure, and are not intended to limit the scope of the present disclosure in any way. With respect to the disclosed methods, the steps presented are exemplary in nature, and thus the order of steps is not necessary or critical unless otherwise disclosed.

The following description of the technology is only exemplary in nature with respect to the subject matter, manufacture and use of one or more inventions, and is not intended to limit the scope, application or use of any particular invention claimed in the present application or in other applications that may be filed claiming the priority of the present application, or the patents issued thereby. With respect to the disclosed methods, the order of the steps presented is exemplary in nature, and thus, in various embodiments, the order of the steps may be different, including where certain steps may be performed simultaneously, unless explicitly stated otherwise. As used herein, “a” and “an” mean that “at least one” term is present; if possible, multiple such terms may be present. Unless specifically stated otherwise, all numerical quantities in this description should be understood to be modified by the word “approximately” and all geometric and spatial descriptors should be understood to be modified by the wording “substantially” in describing the broadest scope of the technology. When applied to numerical values, “approximately” means that the allowable value of calculation or measurement has some slight inaccuracy (some of the values are close to accuracy; approximate or reasonably close to the value; almost). If for some reason, inaccuracies caused by “approximately” and/or “generally” cannot be understood in this general sense in the art, then “approximately” and/or “generally” as used herein at least represent changes that can be made by ordinary methods of measuring or using these parameters.

Unless otherwise expressly indicated, all documents cited in the Detailed Description, including patents, patent applications, and scientific literature, are incorporated herein by reference. In case of any conflict or ambiguity between the literature incorporated by reference and this specific embodiment, this specific embodiment shall prevail.

Although open-ended terms such as “comprising” including, containing, or having synonyms are used herein to describe and require the protection of embodiments of the present technology, embodiments may alternatively be described using more restrictive terms, such as “consisting of” or “substantially consisting of”.

As described herein, unless otherwise indicated, all constituent percentages are based on the weight of the total composition. Unless otherwise specified, the disclosure of ranges includes endpoints, and includes all different values within the entire range and further divided ranges.

When an element or layer is referred to as being “on”, “engaged to”, “connected to”, or “coupled to” another element or layer, it can be directly on, engaged to, connected to, or coupled to the other element or layer, or intervening elements or layers may be present. In contrast, when an element is referred to as being “directly on”, “directly engaged to”, “directly connected to”, or “directly coupled to” another element or layer, there may be no intervening elements or layers present. Other words used to describe the relationship between elements should be interpreted in a similar manner (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. As used herein, the terms “first,” “second,” and other numerical terms do not denote order or sequence unless the context clearly dictates otherwise. Thus, a first element, component, region, layer or section discussed below could be termed a second element, component, region, layer or section without departing from the teachings of example embodiments. One or more examples of the present disclosure are illustrated in the accompanying drawings. Numerical and alphabetic symbols are used in the detailed description to refer to the features in the drawings. Similar or analogous symbols in the drawings and descriptions have been used to refer to like or analogous parts of the present disclosure. As used herein, the terms “first”, “second”, “third”, etc., are used interchangeably to distinguish one member from another, and are not intended to represent the location or importance of the individual members.

Spatial relative terms, such as “inside”, “outside”, “beneath”, “under”, “below”, “on”, “above”, and the like, may be used herein to describe the relationship between one element or feature and another element or feature as shown in the figures. In addition to the orientation shown in the figures, spatial relative terms may be intended to encompass different orientations of the device in use or operation. For example, if the device in the figures is turned over, elements described as “below” or “beneath” other elements or features would then be oriented “above” the other elements or features. Thus, the exemplary term “below” can encompass both an orientation of on and under. The device may be otherwise positioned (rotated 90 degrees or at other orientations) and the spatial relative descriptors used herein interpreted accordingly. In the description of the present disclosure, orientation or position relationships indicated by terms such as “longitudinal”, “lateral”, “up”, “down”, “front”, “rear”, “left”, “right”, “vertical”, “horizontal”, “top”, and “bottom” are based on orientation or position relationships shown in the accompanying drawings, which are only used to facilitate description of the present disclosure rather than requiring that the present disclosure must be constructed and operated in a specific orientation, and therefore cannot be construed as a limitation on the present disclosure. The terms “connecting”, “connected” and “provided” used in the present disclosure should be understood broadly, for example, may be fixed connections or detachable connections; may be direct connections or indirect connections via intermediate components; may be wired connections or radio connections; and may also be wireless communication signal connections. For a person of ordinary skill in the art, the specific meaning of the terms may be understood according to specific situations.

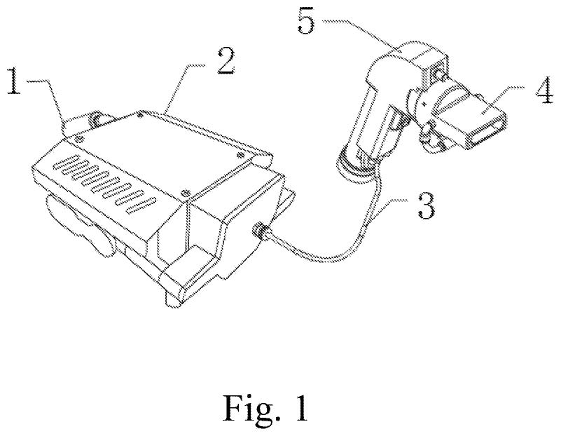

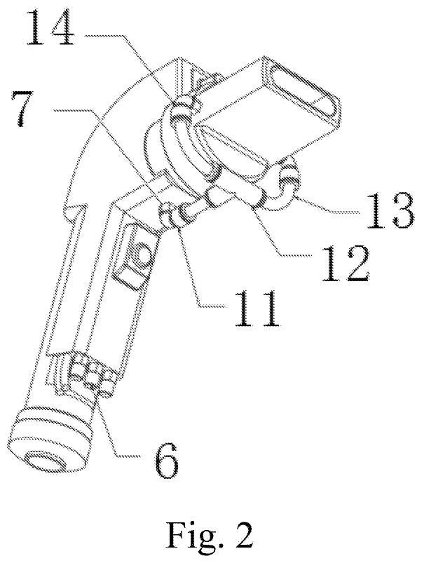

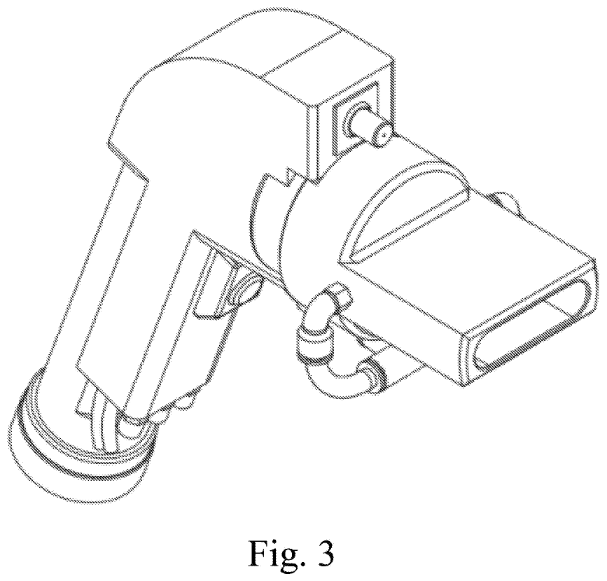

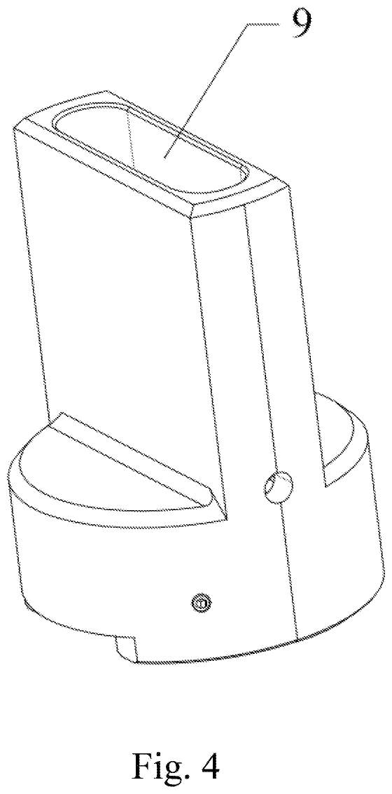

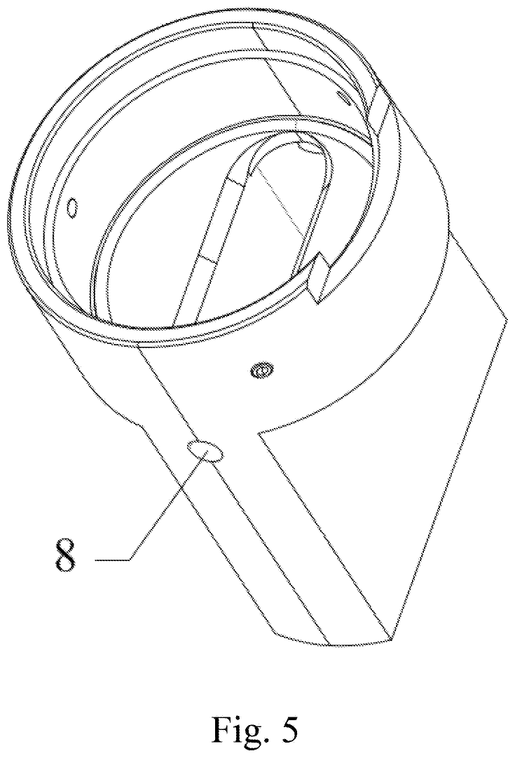

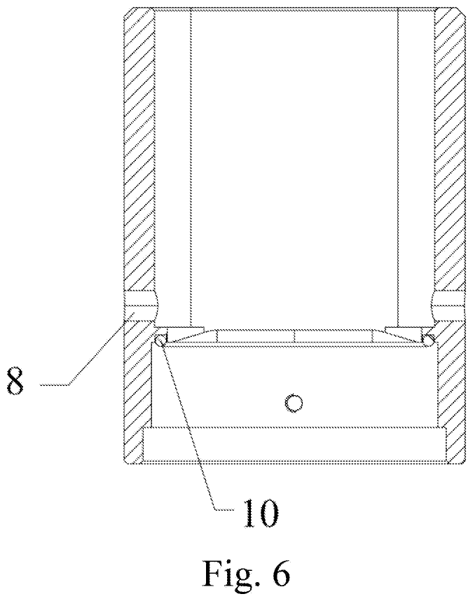

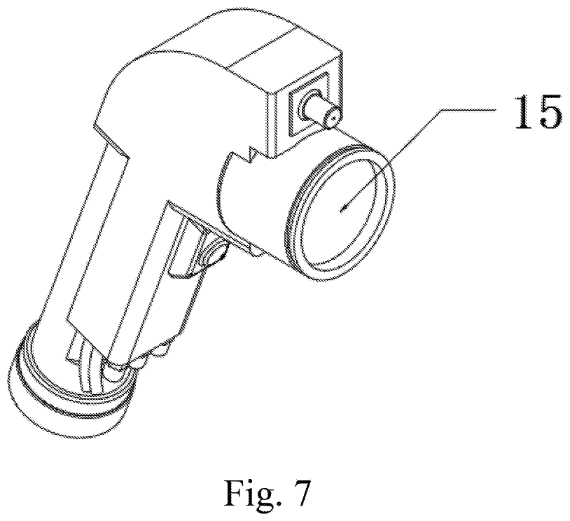

As shown in FIG. 1 to FIG. 7, according to an embodiment of the present disclosure, provided is a dust removal system for a laser cleaning machine, comprising: a filter 1, a gas pump 2, a gas pipe 3 and a dustproof nozzle 4, wherein the dustproof nozzle 4 is fixed on a laser cleaning head 5, a laser cleaning head gas inlet 6 and a laser cleaning head gas outlet 7 are provided on the laser cleaning head 5; one end of the gas pump 2 is connected to the filter 1, and the other end of the gas pump is connected to the laser cleaning head gas inlet 6 by means of the gas pipe 3; a dustproof nozzle gas inlet 8 is provided on both sides of the dustproof nozzle 4, a dustproof nozzle gas outlet 9 is provided on the front end of the dustproof nozzle; and the laser cleaning head gas outlet 7 is connected to the dustproof nozzle gas inlet 8 by means of a pipeline assembly.

In the embodiment of the present disclosure, the pipeline assembly comprises a main gas inlet elbow 11, bypass three-way pipes 12, branch gas pipes on two sides 13, and branch gas inlet elbows on two sides 14, and the laser cleaning head gas outlet 7 is correspondingly connected to the dustproof nozzle gas inlet 8 by means of the main gas inlet elbow 11, the bypass three-way pipes 12, the branch gas pipe elbows 13 on the two sides, and the branch gas inlet elbows 14 on the two sides; and wherein the dustproof nozzle gas inlet 8 is in threaded connection, facilitating the threaded connection with the branch gas inlet elbows 14 on the two sides.

The working principle of the present disclosure is as follows: gas passes through the filter 1 to filter the dust in the air and enters the gas pump 2 for pressurization, then reaches the interior of the laser cleaning head 5 by means of the gas pipe 3, and then passes through the gas inlet elbow 11, the bypass three-way pipes 12 and the gas pipe elbows 13 on the two sides in sequence to achieve two-sided facing blowing (symmetrical air blowing), so that a positive pressure of gas is formed inside the dustproof nozzle 4 from inside to outside, and gas is blown out by means of the dustproof nozzle gas outlet 9, so as to ensure that a lens 15 of the laser cleaning head is isolated from dust, and the lens is free from dust pollution.

In the embodiments of the present disclosure, one end of the dustproof nozzle 4 is of a circular structure and is in threaded connection with the laser cleaning head 5, and a seal ring 10 is provided at a connection end face, achieving a sealing effect; and the other end of the dustproof nozzle 4 is of a flat structure, reducing the probability of dust entering, and increasing the internal positive pressure, causing that positive pressure gas is blown out in the form of an air curtain, thereby improving the dust resistance capability.

The above description is only the preferred embodiments of the present disclosure, and is not intended to limit the present disclosure. For those skilled in the art, the present disclosure may have various modifications and variations. Any modifications, equivalent replacements, improvements and the like made within the spirit and principle of the present disclosure shall belong to the protection scope of the present disclosure.

1. A dust removal system for a laser cleaning machine, comprising: a filter, a gas pump, a gas pipe, and a dustproof nozzle, wherein the dustproof nozzle is fixed on a laser cleaning head, a laser cleaning head gas inlet and a laser cleaning head gas outlet are provided on the laser cleaning head; one end of the gas pump is connected to the filter, and the other end of the gas pump is connected to the laser cleaning head gas inlet by means of the gas pipe; a dustproof nozzle gas inlet is provided on both sides of the dustproof nozzle, a dustproof nozzle gas outlet is provided on the front end of the dustproof nozzle, and the laser cleaning head gas outlet is connected to the dustproof nozzle gas inlet by means of a pipeline assembly; gas passes through the filter to filter the dust in the air and enters the gas pump for pressurization, then reaches the interior of the laser cleaning head by means of the gas pipe, and is blown out of the dustproof nozzle gas outlet by blowing on both sides of the pipeline assembly to form an internal positive pressure.

2. The dust removal system for a laser cleaning machine of claim 1, wherein the pipeline assembly comprises a main gas inlet elbow, bypass three-way pipes, branch gas pipes on two sides, and branch gas inlet elbows on two sides, and the laser cleaning head gas outlet is correspondingly connected to the dustproof nozzle gas inlet by means of the main gas inlet elbow, the bypass three-way pipes, the branch gas pipes on the two sides, and the branch gas inlet elbows on the two sides.

3. The dust removal system for a laser cleaning machine of claim 1, wherein one end of the dustproof nozzle is of a circular structure and in bolted connection with a laser cleaning head, and the other end of the dustproof nozzle is of a flat structure.

4. The dust removal system for a laser cleaning machine of claim 1, wherein a seal ring is provided at a connection end face of the dust-proof nozzle and the laser cleaning head.

5. The dust removal system for a laser cleaning machine of claim 1, wherein the dustproof nozzle gas inlet is in threaded connection.
